(19) United States
(12) Patent Application Publication
(10) Pub. No.: US 2023/0419158 A1
(43) Pub. Date: Dec. 28, 2023

(54) METHOD FOR DETERMINING QND FIDELITY, DEVICE AND STORAGE MEDIUM

(71) Applicant: Beijing Baidu Netcom Science Technology Co., Ltd., Beijing (CN)

(72) Inventors: He WANG, Beijing (CN); Ya CAO, Beijing (CN)

(21) Appl. No.: 18/079,313

(22) Filed: Dec. 12, 2022

(30) Foreign Application Priority Data
Jun. 22, 2022 (CN) 202210727736.3

(51) Int. Cl. G06N 10/70

(52) U.S. Cl. CPC G06N 10/70

(57) ABSTRACT

Provided are a method for determining QND fidelity, a device and a storage medium, and relates to the field of computer, and in particular, to the field of quantum computation. The method includes: determining a sub-Quantum Non-Demolition (QND) fidelity Qₖ obtained after a quantum measurement of a k^{th} input quantum state; where k is any one of 0, 1, 2 . . . , or N−1, and N is a natural number greater than or equal to 1 and represents a quantity of input quantum states required; and obtaining a target QND fidelity based on the sub-QND fidelity Qₖ, where the target QND fidelity is used to measure whether the quantum measurement satisfies a QND property. In this way, the QND property of the quantum measurement can be effectively measured based on the target QND fidelity.

### CROSS-REFERENCE TO RELATED APPLICATIONS

The present application claims priority to Chinese Patent Application No. CN 202210727736.3, filed with the China National Intellectual Property Administration on Jun. 22, 2022, the disclosure of which is hereby incorporated herein by reference in its entirety.

### TECHNICAL FIELD

The present disclosure relates to the field of computer technologies, and in particular, to the field of quantum computation.

### BACKGROUND

Quantum computers are expected to solve problems that cannot be effectively solved by classical computers, have broad application prospects, and thus have received great attention from the scientific research and industrial circles. However, it is quite difficult to experimentally construct a general-purpose quantum computer. In order to measure whether a physical system is suitable for realizing the general-purpose quantum computer, and to guide the construction of the quantum computer, Divincenzo proposed the widely-used criteria, including five criteria in total: extensible qubit, initialization of qubit, long coherence time, universal quantum gate and reading of qubit, which are called Divincenzo criteria. Obviously, the reading of qubit is an indispensable and important link in the process of constructing the quantum computer.

### SUMMARY

The present disclosure provides a method and apparatus for determining QND fidelity, a device and a storage medium.

According to an aspect of the present disclosure, provided is a method for determining QND fidelity, including: determining a sub-Quantum Non-Demolition (QND) fidelity Qₖ obtained after a quantum measurement of a k^{th} input quantum state; where k is any one of 0, 1, 2 . . . , or N−1, and N is a natural number greater than or equal to 1 and is a quantity of input quantum states required; and obtaining a target QND fidelity based on the sub-QND fidelity Qₖ, where the target QND fidelity is used to measure whether the quantum measurement satisfies a QND property.

According to another aspect of the present disclosure, provided is an apparatus for determining QND fidelity, including: a sub-fidelity determining unit configured to determine a sub-Quantum Non-Demolition (QND) fidelity Qₖ obtained after a quantum measurement of a k^{th} input quantum state; where k is any one of 0, 1, 2 . . . , or N−1, and N is a natural number greater than or equal to 1 and represents a quantity of input quantum states required; and a target fidelity determining unit configured to obtain a target QND fidelity based on the sub-QND fidelity Qₖ, where the target QND fidelity is used to measure whether the quantum measurement satisfies a QND property.

According to yet another aspect of the present disclosure, provided is a quantum measurement device, including: a quantum reading module configured to obtain a k^{th} input quantum state, and perform a quantum measurement on the kth input quantum state to obtain a k^{th} output quantum state; and a processing unit configured to determine a sub-QND fidelity Qₖ obtained after the quantum measurement of the kth input quantum state; where k is any one of 0, 1, 2 . . . , or N−1, and N is a natural number greater than or equal to 1 and represents the quantity of input quantum states required; and obtain a target QND fidelity based on the sub-QND fidelity Qₖ, where the target QND fidelity is used to measure whether the quantum measurement satisfies a QND property.

According to yet another aspect of the present disclosure, provided is an electronic device, including: at least one processor; and a memory connected in communication with the at least one processor; where the memory stores an instruction executable by the at least one processor, and the instruction, when executed by the at least one processor, enables the at least one processor to execute the method of any embodiment of the present disclosure.

According to yet another aspect of the present disclosure, provided is a non-transitory computer-readable storage medium storing a computer instruction thereon, and the computer instruction is used to cause a computer to execute the method of any embodiment of the present disclosure.

According to yet another aspect of the present disclosure, provided is a computer program product including a computer program, and the computer program implements the method of any embodiment of the present disclosure, when executed by a processor.

In this way, the QND property of the quantum measurement can be effectively measured based on the target QND fidelity.

It should be understood that the content described in this part is not intended to identify key or important features of embodiments of the present disclosure, nor is it used to limit the scope of the present disclosure. Other features of the present disclosure will be easily understood by the following description.

### BRIEF DESCRIPTION OF THE DRAWINGS

The accompanying drawings are used to better understand the present solution, and do not constitute a limitation to the present disclosure.

FIG. 1 is a schematic diagram of a realization flow of a method for determining QND fidelity F_{Q}.

FIG. 2 is a schematic diagram of the relationship between a QND fidelity F_{Q} and a QND property.

FIG. 3 is a first schematic diagram of a realization flow of a method for determining QND fidelity according to an embodiment of the present application.

FIG. 4 is an association relationship among the target theoretical QND fidelity, the target experimental QND fidelity and the QND property (or the QND measurement) according to an embodiment of the present application.

FIG. 5 is a second schematic diagram of a realization flow of a method for determining QND fidelity according to an embodiment of the present application.

FIG. 6 is a third schematic diagram of a realization flow of a method for determining QND fidelity according to an embodiment of the present application.

FIGS. 7(a) and 7(b) are schematic diagrams of a first quantum measurement and a second quantum measurement of the method for determining QND fidelity in a specific example according to an embodiment of the present application.

FIG. 8 is a schematic diagram of a realization flow of a method for determining the target theoretical QND fidelity in a specific example according to an embodiment of the present application.

FIG. 9 is a schematic diagram of a realization flow of a method for determining the target experimental QND fidelity in a specific example according to an embodiment of the present application.

FIG. 10 is a schematic structural diagram of an apparatus for determining QND fidelity according to an embodiment of the present disclosure.

FIG. 11 is a schematic structural diagram of a quantum measurement device according to an embodiment of the present disclosure.

FIG. 12 is a block diagram of an electronic device used to implement the method for determining QND fidelity according to an embodiment of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope and spirit of the present disclosure. Likewise, for clarity and conciseness, descriptions of well-known functions and structures are omitted in the following descriptions.

The reading of a qubit may be achieved by quantum measurement, for example, measuring the state of the qubit (i.e., quantum state). In order to read the state of the qubit better, the quantum measurement used needs to satisfy the Quantum Non-Demolition (QND) criterion, so as to achieve the quantum non-demolition qubit reading.

The quantum non-demolition is an important criterion guiding the design of the qubit reading apparatus. In order to describe the quantum non-demolition, the Quantum Non-Demolition fidelity (QND fidelity) is defined. Herein, the value of the QND fidelity is usually a real number between 0 and 1. For example, theoretically, 0 means that the QND criterion (or the QND property) is not satisfied at all, and 1 means that the QND property is satisfied.

Herein, the quantum measurement that satisfies the QND property may be called a QND measurement. The QND measurement has the property of avoiding reaction, that is, the expected value of the observation of the QND measurement remains unchanged during the measurement process. In other words, the qubit reading apparatus has a small reaction to the quantum system. This property (that is, the expected value of the observation remains unchanged during the measurement process) may be called the QND property.

In order to achieve the reading of qubit with high fidelity, the QND measurement is widely used in the field of qubit reading. For example, in the superconducting quantum computation, in order to achieve the reading of superconducting qubit state with high fidelity, the dispersion reading scheme is generally used in the industry, while the dispersion reading works in the dispersion region, realizing the qubit reading scheme that approximately satisfies the QND property.

Further, the QND measurement is also defined in the following manner, specifically: in a quantum system to be measured, for an observation O (O is the Hermitian operator) on the quantum system to be measured (for example, an observable quantity of qubits in the quantum system to be measured, or an observable quantity of any subsystem of the quantum system to be measured, etc.), if the observation O satisfies [H, O]=0, where H represents the Hamiltonian of a composite system consisted of the quantum system to be measured and the qubit reading apparatus, then the evolution of the observation O in the Heisenberg picture is invariable, namely

$$\frac{dO}{dt} = 0 .$$

At this time, the observation O may be called a QND observation. Further, for any density matrix ρ, the expected value of the observation O is denoted as [symbol] O [symbol] =Tr[Oρ], and then

$$\frac{d 〈 O 〉}{dt} = 0 .$$

The quantum measurement that satisfies this condition may be called the QND measurement. Herein, the density matrix p represents the density matrix of the quantum system to be measured, and Tr[Oρ] represents the measurement result obtained by performing quantum measurement on the observation O in the quantum system to be measured with the density matrix of p.

Herein, the quantum measurement may be further denoted as a quantum operation. At this time, the Kraus operator of the quantum measurement may be recorded as Mₘ; and further, Eₘ=Mₘ^{†}Mₘ may be defined. At this time, E m may be called POVM (Positive Operator-Valued Measure) element of the quantum measurement, and Mₘ^{†} represents the transposed conjugate matrix of the matrix Mₘ. As can be seen from the language of the quantum operation, the QND measurement may be further defined as: for all the observations O that can be spectrally decomposed using a projection operator {|k [symbol] k|}, and for any quantum system to be measured, the quantum system to be measured is represented by the density matrix p and satisfies: Tr[Oρ]=Tr[Oε(ρ)].

Herein, ε(p)=ΣmMₘρMₘ^{†}, representing the average quantum state after the quantum measurement of the quantum system to be measured, where m is 0, 1, 2 . . . , or N−1. Based on this, it can be proved that the QND measurement is equivalent to the Kraus operator Mₘ of the quantum measurement which has only diagonal elements.

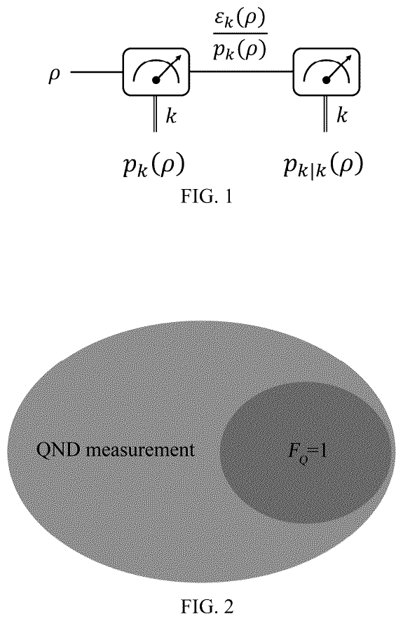

In the experiment, in order to characterize the QND property in the qubit reading process and guide the design of a qubit reading scheme that conforms to the QND property, the QND fidelity may be obtained by the experimental method shown in FIG. 1, so as to characterize the QND property of qubit reading through the QND fidelity; and specifically, the input quantum state of which the density matrix ρ is |k [symbol] k| is measured twice, and the probability that the measurement results of the two quantum measurements both output k is defined as the QND fidelity of the quantum measurement, where the QND fidelity obtained in this way is denoted as F_{Q}.

As shown in FIG. 1, the specific steps include the followings.

The first quantum measurement (that may be represented by the Kraus operator Mₖ) is performed on the input quantum state of which the density matrix ρ is |k [symbol] k|. At this time, the probability distribution that the measurement result of the first quantum measurement outputs k is pₖ(ρ)=Tr[Eₖρ].

Herein, pₙⱼₘ(ρ) may represent the probability that the measurement result of the first quantum measurement outputs m and the measurement result of the second quantum measurement outputs n in the process of performing the quantum measurements on the input quantum state of which the density matrix is ρ; where

$${p}_{n \vert m} ( ρ ) = \frac{Tr [ {M}_{m}^{†} {E}_{n} {M}_{m} ρ ]}{T r [ {E}_{m} ρ ]}$$

for any density matrix ρ.

Further, the probability that two measurement results both output k may be derived based on

$${p}_{n \vert m} ( ρ ) = \frac{Tr [ {M}_{m}^{†} {E}_{n} {M}_{m} ρ ]}{Tr [ {E}_{m} ρ ]} ;$$

and specifically, the second quantum measurement is performed on the output quantum state εₖ(ρ)/pₖ(ρ) of which the output result of the first quantum measurement is K (the Kraus operator used in the second quantum measurement is also denoted by Mₖ), to obtain the probability that the measurement result of the second quantum measurement also outputs k. At this time, the probability that two measurement results both output k is used as the QND fidelity F_{Q,k} corresponding to the input quantum state of which the density matrix ρ is |k [symbol] k|, specifically: F_{Q,k}=pₖ(|k [symbol] k|)p_{k|k}(|k [symbol] k|)= [symbol] k|Mₖ^{†}EₖMₖ|k [symbol] ; where 0≤pₖ(|k [symbol] k|)≤1 and 0≤p_{k|k}(|k [symbol] k|)≤1.

Therefore, the QND fidelity is F_{Q,k}=1 when and only when [symbol] k|Mₖ^{†}EₖMₖ|k [symbol] =1. Further, the QND fidelity F_{Q} is defined as the average value of F_{Q,k}, namely:

$${F}_{Q} = \frac{1}{N} {Σ}_{k} {F}_{Q , k} .$$

Herein, k=0, 1, . . . , N−1, where N is a natural number greater than or equal to 1 and represents the quantity of output quantum states required.

Based on the above analysis, it can be seen that the QND fidelity F_{Q}=1 when and only when [symbol] k|Mₖ^{†}EₖMₖ|k [symbol] =1 for any k. It can be further proved that: the QND fidelity F_{Q}=1 when and only when the measured Kraus operator Mₘ satisfies Mₘ=e^{iθm}|m [symbol] m|, where θₘ is any real number, and Mₘ=e^{iθm}|m [symbol] m| is equivalent to the quantum measurement being an ideal projection measurement. In other words, the QND fidelity F_{Q}=1 when and only when the quantum measurement is an ideal projection measurement.

To sum up, the above-mentioned QND fidelity F_{Q} has the following problems.

1. The QND measurement is equivalent to the Kraus operator Mₘ of the quantum measurement which has only diagonal elements, that is, the QND fidelity F_{Q}=1 when and only when the Kraus operator Mₘ of the quantum measurement satisfies Mₘ=e^{iθ}^{ₘ}|m [symbol] m|. In other words, as shown in FIG. 2, when the quantum measurement satisfies the QND property, the QND fidelity F_{Q} is not necessarily equal to 1, and is also affected by other errors. Obviously, the QND fidelity F_{Q} deviates from the characterization of the QND property.

2. The QND fidelity F_{Q}=1 when and only when the measurement is an ideal projection measurement, that is, the QND fidelity F_{Q} is designed to measure the gap between the actual measurement and the ideal projection measurement, but not to characterize the QND property.

In order to solve the above problems, the disclosed solution proposes a solution for quantitatively characterizing the QND property in qubit reading; and the specific content is as follows.

Firstly, a theoretical QND fidelity (that is, the above target theoretical QND fidelity) is proposed, and may be denoted as Q_{D}. The quantum measurement satisfies the QND property when and only when the theoretical QND fidelity Q_{D}=1. In other words, the theoretical QND fidelity Q_{D} may completely and equivalently characterize the QND property of the quantum measurement. The theoretical QND fidelity Q_{D} may be directly obtained by some experimental methods, for example, the chromatography is performed on the quantum measurement process to obtain the complete measurement process and then obtain the theoretical QND fidelity Q_{D}. Specifically, the disclosed solution also designs a simple experiment to obtain the theoretical QND fidelity Q_{D}. The main steps include: taking the computational basis state |k [symbol] k| as an input quantum state, measuring the computational basis state to obtain an output quantum state ε(|k [symbol] k|), and performing the quantum state chromatography on the output quantum state ε(|k [symbol] k|), to thereby calculate the trace distance D(|k [symbol] k|), ε(|k [symbol] k|)) between the output quantum state ε(|k [symbol] k|) and the input computational basis state |k [symbol] k| as well as the fidelity Q_{D,k} between the output quantum state ε(|k [symbol] k|) and the computational basis state |k [symbol] k|, and finally obtain the theoretical QND fidelity

$${Q}_{D} = \frac{1}{N} {\sum }_{k} {Q}_{D , k} , where k = 0 , 1 , … , N - 1.$$

Secondly, in order to more efficiently characterize the QND property experimentally, the disclosed solution also proposes an experimental QND fidelity (that is, the target experimental QND fidelity), which may be denoted as Q_{E}. When the quantum measurement satisfies the QND property, the experimental QND fidelity Q_{E}=1; and when the experimental QND fidelity Q_{E}=1, the quantum measurement must satisfy the QND property under certain constraints. Based on this, the experimental QND fidelity Q_{E} may also be used to characterize the QND property of the measurement under certain constraints. The disclosed solution further proves that the experimental QND fidelity Q_{E} is an achievable upper limit of the theoretical QND fidelity Q_{D}. Herein, since the experimental QND fidelity Q_{E} may be efficiently obtained experimentally, the upper limit of the theoretical QND fidelity Q_{D} may be efficiently estimated experimentally by using the experimental QND fidelity Q_{E}. Therefore, it can be seen that the experimental QND fidelity Q_{E} provided in the disclosed solution also has practical significance, and can partially reflect the QND property of the measurement.

In general, the QND fidelity (i.e., the theoretical QND fidelity Q_{D}, and/or the experimental QND fidelity Q_{E}) proposed in the disclosed solution can characterize the physical nature of the measurement better, where the physical nature means that the expected value of the observation is unchanged before and after the measurement for the QND measurement.

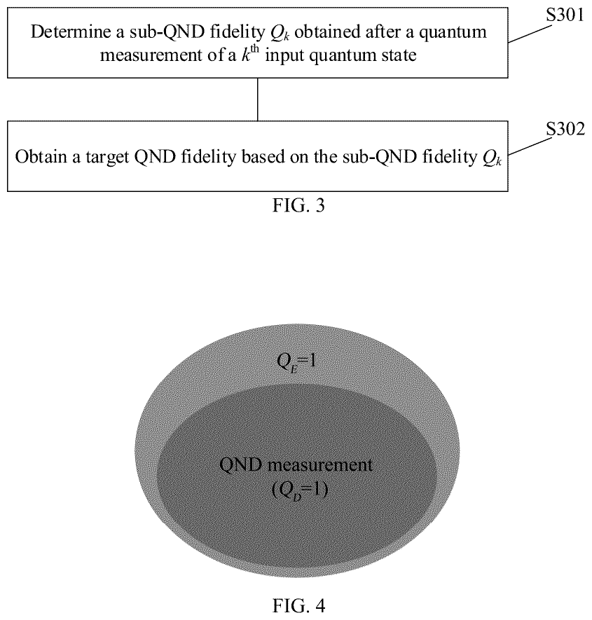

Specifically, FIG. 3 is a first schematic flowchart of a method for determining QND fidelity according to an embodiment of the present application. This method may optionally be applied to a classical computing device, such as a personal computer, a server, a server cluster, and any other electronic device with classical computing capability, or applied to a quantum measurement device with classical computing capability. In this case, the quantum measurement device can read the state of a qubit, that is, can perform the quantum measurement, such as quantum state chromatography, etc.; and the quantum measurement device may also be called a qubit reading apparatus.

Further, this method includes at least a part of the following content. Specifically, as shown in FIG. 3, this method includes the followings.

Step S301: determining a sub-QND fidelity Qₖ obtained after a quantum measurement of a k^{th} input quantum state; where k is any one of 0, 1, 2 . . . , or N−1, and N is a natural number greater than or equal to 1 and is a quantity of input quantum states required. Herein, N also represents a quantity of output results of the quantum measurement device corresponding to the quantum measurement.

It should be noted that the quantum measurement device will output two types of results after the quantum measurement, where the first type is classical data, such as 0, 1, 2, etc., and the second type is a quantum state.

Step S302: obtaining a target QND fidelity based on the sub-QND fidelity Qₖ, where the target QND fidelity is used to measure whether the quantum measurement satisfies a QND property.

Herein, whether the quantum measurement satisfies the QND property may also be referred to as whether the quantum measurement is a QND measurement. The QND measurement means that the expected value of the observation remains unchanged during the quantum measurement process. At this time, the property that the expected value of the observation remains unchanged during the quantum measurement process is correspondingly called the QND property.

In this way, the QND property of the quantum measurement can be effectively measured based on the target QND fidelity, and thus the quantum measurement device can be measured, providing support for guiding the design of a qubit reading scheme that conforms to the QND property.

In a specific example of the disclosed solution, the above step of obtaining the target QND fidelity based on the sub-QND fidelity Qₖ may specifically include: obtaining an average QND fidelity corresponding to the quantum measurement based on the sub-QND fidelity Qₖ; and taking the average QND fidelity as the target QND fidelity. For example, in the case where k is 0, 1, 2 . . . , or N−1, N sub-QND fidelities Qₖ are obtained, and the average value of the N sub-QND fidelities Qₖ, i.e., the average QND fidelity, is directly taken as the target QND fidelity, thus providing a convenient way to quickly obtain the target QND fidelity, and thereby facilitating the rapid measurement of the QND property of the quantum measurement.

In a specific example of the disclosed solution, the target QND fidelity includes at least one of: 1. a target theoretical QND fidelity Q_{D}, where the target theoretical QND fidelity Q_{D} is within a first preset range when and only when the quantum measurement satisfies the QND property; that is, as shown in FIG. 4, the target theoretical QND fidelity Q_{D} can completely and equivalently characterize the QND property of the quantum measurement; or 2. a target experimental QND fidelity Q_{E}, where the quantum measurement satisfies the QND property, in the case where the target experimental QND fidelity Q_{E} is within the first preset range and the quantum measurement satisfies a preset condition. That is, as shown in FIG. 4, the target experimental QND fidelity Q_{E} may also be used to characterize the QND property of the measurement under certain constraints.

Herein, in a specific example, the quantum measurement satisfying the preset condition means that the POVM element E m used in the quantum measurement has only diagonal elements which are linearly independent of each other. The specific proof may refer to the following description and will not be repeated herein.

In a specific example, the target theoretical QND fidelity Q_{D} or the target experimental QND fidelity Q_{E} is a real number between 0 and 1. In theory, the target theoretical QND fidelity Q_{D}=1 when and only when the quantum measurement satisfies the QND property; and the quantum measurement satisfies the QND property in the case where the target experiment QND fidelity Q_{E}=1 and the quantum measurement satisfies the preset condition. Correspondingly, the target theoretical QND fidelity Q_{D}=O or the target experimental QND fidelity Q_{E}=0 indicates that the quantum measurement does not satisfy the QND property at all.

Herein, considering the difference between the actual value and the theoretical value, a threshold value may also be preset, for example, the threshold value is set as 0.9. At this time, the first preset range may be specifically (0.9, 1]. At this time, for the target theoretical QND fidelity Q_{D}, the target theoretical QND fidelity Q_{D} is a value greater than 0.9 and less than or equal to 1 when and only when the quantum measurement satisfies the QND property. Similarly, for the target experimental QND fidelity Q_{E}, as long as it is a value greater than 0.9 and less than or equal to 1 and the quantum measurement satisfies the preset condition, it can be considered that the quantum measurement satisfies the QND property.

It can be understood that the above threshold value is only an example, may be set based on actual requirements, and is not limited in the disclosed solution.

In this way, the target QND fidelity, such as the target theoretical QND fidelity Q_{D} and/or the target experimental QND fidelity Q_{E}, proposed in the disclosed solution can characterize the physical nature of the quantum measurement better, and further provide support for guiding the design of the qubit reading scheme that conforms to the QND property.

In a specific example of the disclosed solution, the target theoretical QND fidelity Q_{D} is within a second preset range when and only when the quantum measurement does not satisfy the QND property. Thus, an effective manner is provided to characterize the QND property of the quantum measurement, and the target theoretical QND fidelity Q_{D} can completely and equivalently characterize the QND property of the quantum measurement, and further provide support for guiding the design of the qubit reading scheme that conforms to the QND property.

In this example, the second preset range is different from the first preset range, and the two ranges do not overlap; continuing to take the threshold value of 0.9 as an example for description, the second preset range may be specifically [0,1] in this case; and further, for the target theoretical QND fidelity Q_{D}, the target theoretical QND fidelity Q_{D} is a value greater than or equal to 0 and less than or equal to 0.9, that is, within the second preset range, when and only when the quantum measurement does not satisfy the QND property.

For example, as shown in FIG. 4, the target theoretical QND fidelity Q_{D}=1 when and only when the quantum measurement satisfies the QND property, and similarly, the target theoretical QND fidelity Q_{D}≠1 when and only when the quantum measurement does not satisfy the QND property, so that the QND property of the measurement is completely and equivalently characterized by the target theoretical QND fidelity Q_{D}.

In a specific example of the disclosed solution, the quantum measurement does not satisfy the QND property in the case where the target experimental QND fidelity Q_{E} is within a second preset range. Thus, an effective manner is provided to characterize the QND property of the quantum measurement, and this manner can characterize the physical nature of the quantum measurement to a certain extent, and further provide support for guiding the design of the qubit reading scheme that conforms to the QND property.

In this example, the second preset range is different from the first preset range, and the two ranges do not overlap; continuing to take the threshold value of 0.9 as an example for description, the second preset range may be specifically [0,1] in this case; and further, for the target experimental QND fidelity Q_{E}, as long as it is a value greater than or equal to 0 and less than or equal to 0.9, that is, within the second preset range, it can be considered that the quantum measurement does not satisfy the QND property.

For example, as shown in FIG. 4, when the quantum measurement satisfies the QND property, the target theoretical QND fidelity Q_{D}=1, and at this time, the target experimental QND fidelity Q_{E}=1. When the target experimental QND fidelity is Q_{E}≠1, the quantum measurement must not be a QND measurement, that is, the quantum measurement must not satisfy the QND property.

In a specific example of the disclosed solution, the target theoretical QND fidelity Q_{D} is less than or equal to the target experimental QND fidelity Q_{E}. That is, the target experimental QND fidelity Q_{E} is an achievable upper limit of the target theoretical QND fidelity Q_{D}. Herein, since the target theoretical QND fidelity Q_{D} can completely and equivalently characterize the QND property of the quantum measurement, the target experimental QND fidelity Q_{E} still has practical significance and can partially reflect the QND property of the quantum measurement.

For example, as shown in FIG. 4, FIG. 4 shows the relationship among the target theoretical QND fidelity Q_{D}, the target experimental QND fidelity Q_{E} and the QND property (i.e., the QND measurement) proposed in the disclosed solution, that is, the target theoretical QND fidelity Q_{D} can completely and equivalently characterize the QND property of the measurement, while the target experimental QND fidelity Q_{E} cannot completely and equivalently characterize the QND property of the measurement, but has more advantages in experimental implementation and can give an achievable upper limit of the target theoretical QND fidelity Q_{D}.

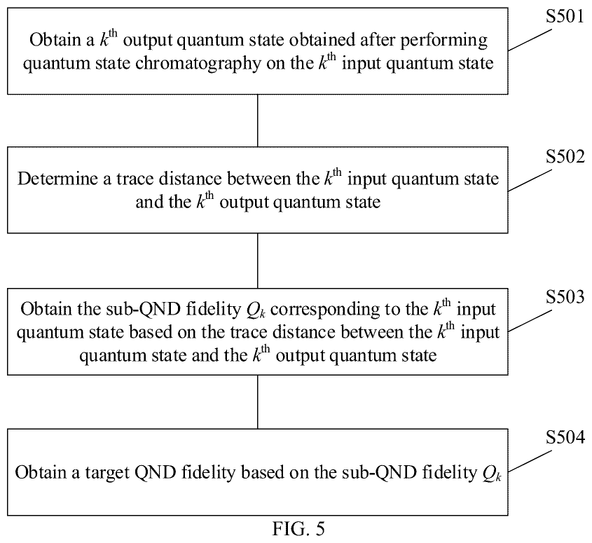

In a specific example of the disclosed solution, a method for determining QND fidelity is provided. Specifically, FIG. 5 is a second schematic flowchart of a method for determining QND fidelity according to an embodiment of the present application. This method may optionally be applied to a classical computing device, such as a personal computer, a server, a server cluster, and any other electronic device with classical computing capability, or applied to a quantum measurement device with classical computing capability. In this case, the quantum measurement device can read the state of a qubit, that is, can perform the quantum measurement, such as quantum state chromatography, etc.; and the quantum measurement device may also be called a qubit reading apparatus.

It can be understood that the relevant content of the method shown in FIG. 3 described above may also be applied to this example, and the relevant content will not be repeated in this example.

Further, this method includes at least a part of the following content. Specifically, as shown in FIG. 5, this method includes the followings.

Step S501: obtaining a k^{th} output quantum state obtained after performing quantum state chromatography on the kth input quantum state.

Step S502: determining a trace distance between the k^{th} input quantum state and the k^{th} output quantum state, where the trace distance between the k^{th} input quantum state and the k^{th} output quantum state is used to measure destructiveness of performing the quantum state chromatography on the k^{th} input quantum state.

Step S503: obtaining the sub-QND fidelity Qₖ corresponding to the k^{th} input quantum state based on the trace distance between the k^{th} input quantum state and the k^{th} output quantum state, where the sub-QND fidelity Qₖ is a sub-theoretical QND fidelity Q_{D,k}.

For example, the sub-QND fidelity corresponding to the k^{th} input quantum state is Q k=1−(the trace distance between the k^{th} input quantum state and the k^{th} output quantum state).

Step S504: obtaining a target QND fidelity based on the sub-QND fidelity Q k, where the target QND fidelity is used to measure whether the quantum measurement satisfies the QND property.

Thus, the disclosed solution provides an experimental method of the target QND fidelity, which is simple and feasible, so that the disclosed solution has both practicability and applicability.

Herein, in a specific example, the step S504 may specifically include: obtaining a target theoretical QND fidelity Q_{D} based on the sub-theoretical QND fidelity Q_{D,k}, where the target theoretical QND fidelity Q_{D} is used to measure whether the quantum measurement satisfies the QND property. Specifically, the target theoretical QND fidelity Q_{D} is a preset value when and only when the quantum measurement satisfies the QND property; and the target theoretical QND fidelity Q_{D} is not the preset value when and only when the quantum measurement does not satisfy the QND property, so that the QND property of the quantum measurement can be completely and equivalently characterized.

Further, in a specific example, the target theoretical QND fidelity Q_{D} may also be obtained in the following manner, which may specifically include: obtaining an average QND fidelity corresponding to the quantum measurement based on the sub-theoretical QND fidelity Q_{D,k}; and then taking the average QND fidelity obtained based on the sub-theoretical QND fidelity Q_{D,k} as the target theoretical QND fidelity Q_{D}. For example, in the case where k is 0, 1, 2 . . . , or N−1, N sub-theoretical QND fidelities Q_{D,k} are obtained, and the average value of the N sub-theoretical QND fidelities Q_{D,k} is directly taken as the target theoretical QND fidelity Q_{D}, thus providing a convenient way to quickly obtain the target theoretical QND fidelity, and thereby facilitating the rapid measurement of the QND property of the quantum measurement.

In a specific example, the k^{th} input quantum state is a computational basis state |k [symbol] [symbol] k|. Thus, the disclosed solution provides an experimental method of the target QND fidelity, which is simple and feasible, so that the disclosed solution has both practicability and applicability.

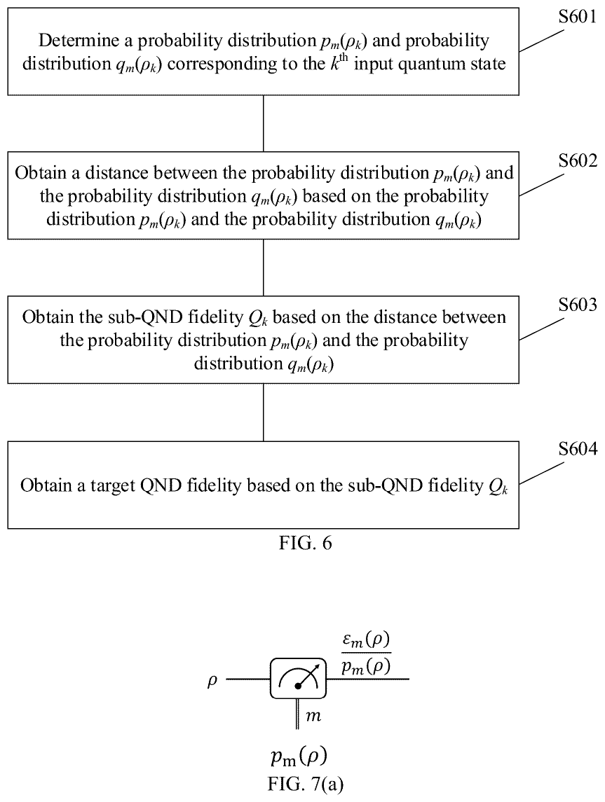

In a specific example of the disclosed solution, a method for determining QND fidelity is provided. Specifically, FIG. 6 is a third schematic flowchart of a method for determining QND fidelity according to an embodiment of the present application. This method may optionally be applied to a classical computing device, such as a personal computer, a server, a server cluster, and any other electronic device with classical computing capability, or applied to a quantum measurement device with classical computing capability. In this case, the quantum measurement device can read the state of a qubit, that is, can perform the quantum measurement, such as quantum state chromatography, etc.; and the quantum measurement device may also be called a qubit reading apparatus.

It can be understood that the relevant content of the method shown in FIG. 3 described above may also be applied to this example, and the relevant content will not be repeated in this example.

Further, this method includes at least a part of the following content. Specifically, as shown in FIG. 6, this method includes the followings.

Step S601: determining a probability distribution pₘ(ρₖ) and probability distribution qₘ(ρₖ) corresponding to the k^{th} input quantum state, where ρₖ is a density matrix of the k^{th} input quantum state, the probability distribution pₘ(ρₖ) represents a probability that an output result of a first quantum measurement of the k^{th} input quantum state is m, and the probability distribution qₘ(ρₖ) represents a probability that an output result of a second quantum measurement of an output quantum state after the first quantum measurement of the k^{th} input quantum state is m.

Step S602: obtaining a distance between the probability distribution pₘ(ρₖ) and the probability distribution qₘ(ρₖ) based on the probability distribution pₘ(ρₖ) and the probability distribution qₘ(ρₖ); where the distance between the probability distribution pₘ(ρₖ) and the probability distribution qₘ(ρₖ) is used to characterize destructiveness of performing the quantum measurement on the k^{th} input quantum state.

Step S603: obtaining the sub-QND fidelity Qₖ corresponding to the k^{th} input quantum state based on the distance between the probability distribution pₘ(ρₖ) and the probability distribution qₘ(ρₖ); where the sub-QND fidelity Qₖ is a sub-experimental QND fidelity Q_{E},k.

For example, the sub-QND fidelity corresponding to the k^{th} input quantum state is Q k=1−(the distance between the probability distribution pₘ(ρₖ) and the probability distribution qₘ(ρₖ)).

Step S604: obtaining a target QND fidelity based on the sub-QND fidelity Qₖ, where the target QND fidelity is used to measure whether the quantum measurement satisfies the QND property.

Thus, the disclosed solution provides another experimental method of the target QND fidelity, which is simple and feasible, so that the disclosed solution has both practicability and applicability.

In a specific example, the step S604 may specifically include: obtaining a target experimental QND fidelity Q_{E} based on the sub-experimental QND fidelity Q_{E,k}, where the target experimental QND fidelity Q_{E} is used to measure whether the quantum measurement satisfies the QND property. Specifically, in the case where the target experimental QND fidelity Q_{E} is a preset value, and the quantum measurement satisfies a preset condition, the quantum measurement satisfies the QND property; and in the case where the target experimental QND fidelity Q_{E} is not the preset value, the quantum measurement does not satisfy the QND property. In this way, the physical nature of the quantum measurement is characterized to a certain extent, further providing support for guiding the design of the qubit reading scheme that conforms to the QND property.

Further, in a specific example, the target experimental QND fidelity Q_{E} may also be obtained in the following manner, which may specifically include: obtaining an average QND fidelity corresponding to the quantum measurement based on the sub-experimental QND fidelity Q_{E,k}; and then taking the average QND fidelity obtained based on the sub-experimental QND fidelity Q_{E,k} as the target experimental QND fidelity Q_{E}. For example, in the case where k is 0, 1, 2 . . . , or N−1, N sub-experimental QND fidelities Q_{E,k} are obtained, and the average value of the N sub-experimental QND fidelities Q_{E,k} is directly taken as the target experimental QND fidelity Q_{E}, thus providing a convenient way to quickly obtain the target experimental QND fidelity, and thereby facilitating the rapid measurement of the QND property of the quantum measurement.

In a specific example, the k^{th} input quantum state is a computational basis state |k [symbol] k|, and ρₖ=|k [symbol] k|. Thus, the disclosed solution provides an experimental method of the target QND fidelity, which is simple and feasible, so that the disclosed solution has both practicability and applicability.

The disclosed solution will be further described in detail below with reference to specific examples; and specifically, the disclosed solution proposes a method for quantitatively characterizing the QND property in qubit reading. Firstly, a theoretical QND fidelity Q_{D} (i.e., a target theoretical QND fidelity) is proposed, where the theoretical QND fidelity Q_{D}=1 when and only when the quantum measurement satisfies the QND property, so the theoretical QND fidelity Q_{D} proposed in the disclosed solution can completely characterize the QND property of the quantum measurement, as shown in FIG. 4; and secondly, in order to experimentally verify the QND properties more efficiently, the disclosed solution further proposes an experimental QND fidelity Q_{E} (i.e., a target experimental QND fidelity) and also gives an experimental method, which can easily calculate the experimental QND fidelity Q_{E} from the experimental result, and at the same time, prove that the experimental QND fidelity Q_{E} is actually an achievable upper limit of the theoretical QND fidelity Q_{D}.

The details will be explained from two parts as follows: the first part introduces the core ideas and experimental methods of the theoretical QND fidelity Q_{D} and experimental QND fidelity Q_{E} proposed in the disclosed solution; and the second part introduces the complete technical implementation scheme of the disclosed solution.

First part: metrics that quantitatively characterize quantum non-demolition

(I) Core idea and experimental method of theoretical QND fidelity Q_{D}

(1) Core Idea

According to the definition of the QND measurement, for a quantum system to be measured, the quantum system to be measured is represented by a density matrix ρ, and for any density matrix ρ, all the observations O (the observed quantities corresponding to the system to be measured) that can be spectrally decomposed using a projection operator {|k [symbol] k|) satisfy: Tr[Oρ]=Tr[OE(ρ)].

Herein, ε(ρ)=ΣₘMₘρMₘ^{†} represents the average quantum state after the quantum measurement of the quantum system to be measured, where m is 0, 1, 2 . . . , or N−1; N represents the quantity of input quantum states required; and Mₘ represents the Kraus operator of the quantum measurement, and MI represents the transposed conjugate matrix of the operator Mₘ. Accordingly, it can be proved that the QND measurement is equivalent to the operator Mₘ of the quantum measurement which has only diagonal elements, and thus it can be proved that the QND measurement is equivalent to: for any k, E(|k [symbol] k|)=|k [symbol] k|. Then, it is equivalent to: D(|k [symbol] k|, ε(|k [symbol] k|))=0.

Herein, D(|k [symbol] k|, ε(|k [symbol] k|)) represents the distance between the input quantum state (that is, the computational basis state) with the density matrix of |k [symbol] k|} and the output quantum state E(|k [symbol] k|), and D(|k [symbol] k|, ε(|k [symbol] k|)) can measure the destructiveness of performing the measurement on the computational basis state ‘Mk’. The larger the value of D, the greater the destructiveness of the measurement.

Herein, for any given density matrix ρ and density matrix a, the distance may also be calculated using the trace distance, specifically:

$$D ( ρ , σ ) = \frac{1}{2} Tr [ \vert ρ - σ \vert ] ;$$

where Tr represents the operator of the trace distance, and |ρ−σ|=\sqrt{(ρ−σ)^{†}(ρ−σ)}. Herein, it can be understood that the quantum states described in the disclosed solution may all be represented by density matrices. Thus,

$$D ( \vert k 〉 〈 k \vert , ε ( \vert k 〉 〈 k \vert ) ) = \frac{1}{2} Tr [ \vert \vert k 〉 〈 k \vert - ε ( \vert k 〉 〈 k \vert ) \vert ] .$$

Based on this, for the computational basis state |k [symbol] k|, the destructiveness of the quantum measurement, that is, the destructiveness of the quantum measurement corresponding to the computational basis state |k [symbol] k|, may be defined, and may be denoted as D_{D,k}, namely:

$${D}_{D , k} = D ( \vert k 〉 〈 k \vert , ε ( \vert k 〉 〈 k \vert ) ) = \frac{1}{2} Tr [ \vert \vert k 〉 〈 k \vert - ε ( \vert k 〉 〈 k \vert ) \vert ] .$$

Herein, D_{D,k} may also be referred to as the trace distance between the computational basis state |k [symbol] k| as the input quantum state and the output quantum state ε(|k [symbol] k|), denoted as the trace distance D_{D,k} corresponding to the computational basis state |k [symbol] k|.

Further, the theoretical QND fidelity corresponding to the computational basis state |k [symbol] k| is obtained, and may be denoted as Q_{D,k}, namely: Q_{D,k}=1−D_{D,k}.

Then, the theoretical QND fidelity Q_{D} of the quantum measurement may be defined as the average value of the theoretical QND fidelities Q_{D,k} corresponding to N computational basis states |k [symbol] k| (k=0, 1, . . . , N−1), namely:

$${Q}_{D} = \frac{1}{N} {Σ}_{k = 0}^{N - 1} {Q}_{D , k} .$$

Herein, the value of N is a natural number greater than or equal to 1, and corresponds to the quantity of energy levels of the quantum system to be measured that needs to be considered.

Herein, it can be understood that, for the convenience of distinction, in the disclosed solution, the theoretical QND fidelity Q_{D,k} corresponding to the computational basis state |k [symbol] k| is called the sub-theoretical QND fidelity Q_{D,k} corresponding to the computational basis state |k [symbol] k|; and correspondingly, the theoretical QND fidelity Q_{D} of the quantum measurement is called the target theoretical QND fidelity Q_{D} of the quantum measurement, and the target theoretical QND fidelity Q_{D} is the average value of all sub-theoretical QND fidelities Q_{D,k}.

Thus, as shown in FIG. 4, the target theoretical QND fidelity Q_{D}=1 when and only when the quantum measurement satisfies the QND property in the disclosed solution. In other words, the target theoretical QND fidelity Q_{D} described in the disclosed solution can completely characterize the QND property of the quantum measurement.

(2) Experimental Method

The target theoretical QND fidelity Q_{D} may be directly obtained by the following experimental method, specifically including the followings.

1. The chromatography is performed on the measurement process. For any density matrix ρ (an input quantum state is represented by the density matrix ρ), after the quantum measurement of the input quantum state, the chromatography may be performed on the measurement process, so as to obtain an output quantum state ε(ρ); and further, the target theoretical QND fidelity Q_{D} may be calculated based on the input quantum state and the output quantum state.

2. A simpler experiment is designed, that is, the computational basis state |k [symbol] k| is used as an input quantum state, and the quantum state chromatography is performed on the computational basis state |k [symbol] k| to obtain an output quantum state ε(|k [symbol] k|), so that the trace distance D(|k [symbol] k|,ε(|k [symbol] k|)) between the output quantum state ε(|k [symbol] k|) and the computational basis state |k [symbol] k| may be calculated, and then the sub-theoretical QND fidelity Q_{D,k} corresponding to the computational basis state |k [symbol] k| is obtained, and finally the target theoretical QND fidelity Q_{D} of the quantum state chromatography is calculated based on N sub-theoretical QND fidelities Q_{D,k}, that is,

$${Q}_{D} = \frac{1}{N} {Σ}_{k = 0}^{N - 1} {Q}_{D , k} .$$

In addition, the disclosed solution also proposes an experimental method, which can estimate the upper limit of the target theoretical QND fidelity Q_{D} more efficiently, for which the disclosed solution defines an experimental QND fidelity Q_{E}. The experimental QND fidelity Q_{E} will be described in detail below.

(II) Core idea and experimental method of experimental QND fidelity Q_{E}

(1) Core Idea

In order to experimentally judge whether the quantum measurement satisfies the QND property according to the measurement result, the disclosed solution defines the experimental QND fidelity Q_{E} and provides an experimental method. Herein, the advantages of the experimental QND fidelity Q_{E} are as follows: it can be easily measured experimentally and can be directly used to characterize the QND property of the quantum measurement under some conditions, and furthermore, can also give an achievable upper limit of the target theoretical QND fidelity Q_{D}.

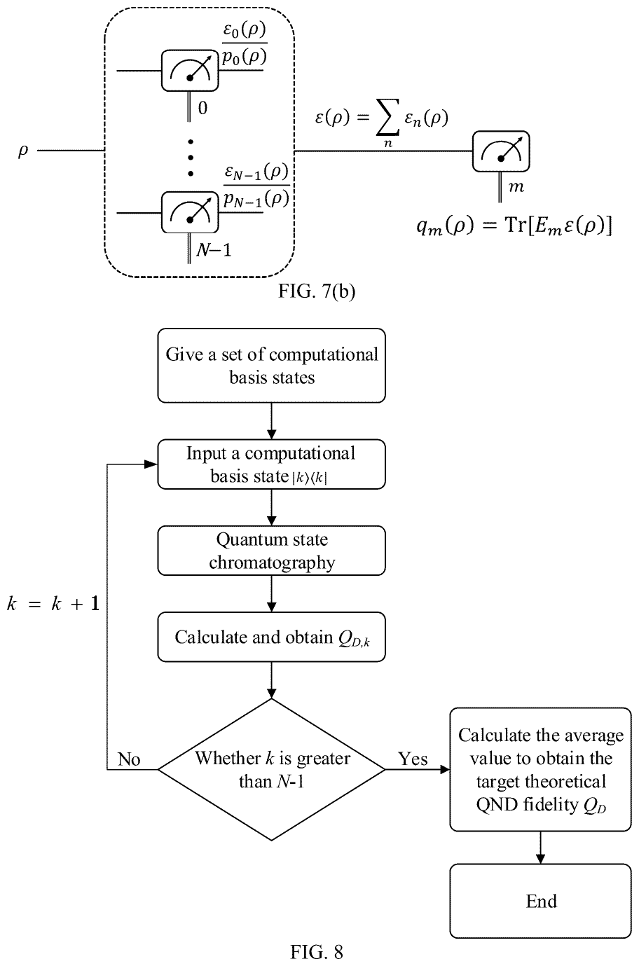

Specifically, as shown in FIG. 7(a) (a schematic diagram where the output result of the first quantum measurement is m) and FIG. 7(b) (a schematic diagram where the output result of the second quantum measurement is m), the density matrix ρ is used as an input, the density matrix ρ represents an input quantum state, the first quantum measurement is performed, the possible output value of the first quantum measurement is one of {0, 1, . . . , n, . . . , N−1}, and the output quantum state is εₙ(ρ)/pₙ(ρ) when the output result of the first quantum measurement is n, where pₙ(ρ) represents the probability that the output result of the first quantum measurement is n.

Herein, the probability distribution that the output result of the first quantum measurement is m may be denoted as pₘ(ρ), namely: pₘ(ρ)=Tr[Eₘρ]; where Eₘ=Mₘ^{†}Mₘ, represents the POVM element of the quantum measurement; Mₘ is the Kraus operator of the quantum measurement, and Mₘ^{†} represents the transposed conjugate matrix of the matrix Mₘ.

Further, p_{n|m}(ρ) may represent the probability that the output result of the input density matrix ρ after the second quantum measurement is n in the case where the output result after the first quantum measurement is m; and, for any density matrix ρ:

$${p}_{n \vert m} ( ρ ) = \frac{Tr [ {M}_{m}^{†} {E}_{n} {M}_{m} ρ ]}{Tr [ {E}_{m} ρ ]} .$$

Herein, Eₘ represents the Kraus operator selected for the first quantum measurement, and Eₙ represents the Kraus operator used for the second quantum measurement in the case where the output result after the first quantum measurement is m.

Further, the output quantum state when the output result of the first quantum measurement is m is denoted as:

$$\frac{{ε}_{m} ( ρ )}{{p}_{m} ( ρ )} = \frac{{M}_{m} {ρM}_{m}^{†}}{{p}_{m} ( ρ )} .$$

Based on this, the average quantum state of the arbitrary value output after the first quantum measurement is:

$$ε ( ρ ) = {Σ}_{n} {p}_{n} ( ρ ) \frac{{ε}_{n} ( ρ )}{{p}_{n} ( ρ )} = {Σ}_{n} {ε}_{n} ( ρ ) .$$

Further, the second quantum measurement is performed on the output quantum state (may be represented by the average quantum state) after the first quantum measurement, and the probability distribution that the output result of the second quantum measurement is m is qₘ(ρ), namely:

$${q}_{m} ( ρ ) = {Σ}_{n} {p}_{n} ( ρ ) {p}_{m \vert n} ( ρ ) = {Σ}_{n} {p}_{n} ( ρ ) \frac{T r [ {E}_{m} {ε}_{n} ( ρ ) ]}{{p}_{n} ( ρ )} = T r [ {E}_{m} ε ( ρ ) ] .$$

Herein, pₘ(ρ) and qₘ(ρ) are two classical probability distributions, and the distance between the classical probability distributions may be defined as:

$$D ( {p}_{m} ( ρ ) , {q}_{m} ( ρ ) ) = \frac{1}{2} {Σ}_{m} \vert {p}_{m} ( ρ ) - {q}_{m} ( ρ ) \vert .$$

At this time, the destructiveness of the quantum measurement may be measured based on the distance between the probability distribution pₘ(ρ) and the probability distribution qₘ(ρ), thereby obtaining the experimental QND fidelity Q_{E}.

(2) Experimental Method

In the experiment, in the experimental step of determining the experimental QND fidelity Q_{E}, only the case where the input quantum state is the computational basis state |k [symbol] k|, that is, the density matrix of the input quantum state is ρ=|k [symbol] k| (k=0, 1, 2 . . . N−1) may be considered; and further, the destructiveness of performing the experimental quantum measurement on the computational basis state |k [symbol] k| may be denoted as D_{E,k}, namely: D_{E,k}=D(pₘ(|k [symbol] k|), qₘ(|k [symbol] k|)).

Then, the experimental QND fidelity corresponding to the computational basis state |k [symbol] k| is obtained, and may be denoted as Q_{E,k}, namely: Q_{E,k}=1−D_{E,k}.

Then, the experimental QND fidelity Q_{E} of the quantum measurement may be defined as the average value of the experimental QND fidelities Q_{E,k} (that is, the average QND fidelity) corresponding to N computational basis states |k [symbol] k| (k=0, 1, . . . , N−1), namely:

$${Q}_{E} = \frac{1}{N} {Σ}_{k = 0}^{N - 1} {Q}_{E , k} .$$

Herein, the value of N is a natural number greater than or equal to 1, and corresponds to the quantity of energy levels to be considered.

It should be noted that the output result of the second quantum measurement is counted without concerning the output result of the first quantum measurement. In other words, in the step of counting the output result of the second quantum measurement as m, the output result of the first quantum measurement may be the same as or different from the output result of the second quantum measurement; for example, the output results of the two quantum measurements are both m, or the output result of the first quantum measurement is n, where n is different from m. Instead, the experimental QND fidelity is defined as

$${Q}_{E} = \frac{1}{N} {Σ}_{k} {Q}_{E , k}$$

by comparing the difference between the classical probability distribution qₘ(ρ) that the output result of the second quantum measurement is m and the classical probability distribution pₘ(ρ) that the output result of the first quantum measurement is m; and Q_{D}≤Q_{E}. Therefore, when the quantum measurement satisfies the QND property, the experimental QND fidelity Q_{E}=1. When Q_{E}=1, a certain condition needs to be satisfied to determine that the quantum measurement satisfies the QND property.

Herein, it can be understood that, for the convenience of distinction, in the disclosed solution, the experimental QND fidelity Q_{E,k} corresponding to the computational basis state |k [symbol] k| is called the sub-experimental QND fidelity Q_{E,k} corresponding to the computational basis state |k [symbol] k|; and correspondingly, the experimental QND fidelity Q_{E} of the quantum measurement is called the target experimental QND fidelity Q_{E} of the quantum measurement, and the target experimental QND fidelity Q_{E} is the average value of all sub-experimental QND fidelities Q_{E,k}.

In this way, the disclosed solution gives the target experimental QND fidelity Q_{E}, and can prove a conclusion of that the target theoretical QND fidelity Q_{D} is less than or equal to the target experimental QND fidelity Q_{E}.

Specifically, as shown in FIG. 4, when the quantum measurement satisfies the QND property, the target experiment QND fidelity Q_{E}=1; and when the target experiment QND fidelity Q_{E}≠1, the quantum measurement must not be a QND measurement, that is, the quantum measurement must not satisfy the QND property.

Further, the disclosed solution can also prove that, when the target experiment QND fidelity Q_{E}=1, if the POVM element E m satisfies that has only diagonal elements and they are linearly independent of each other, then the quantum measurement satisfies the QND property; the above condition is not inconsistent with the projection measurement, and thus is experimentally reasonable. Under the above condition, the target experimental QND fidelity Q_{E} may also be used to completely and equivalently characterize the QND property of the measurement. When the above condition is not satisfied, the target experimental QND fidelity Q_{E} may give an achievable upper limit of the target theoretical QND fidelity Q_{D}; and herein, since the target theoretical QND fidelity Q_{D} can completely and equivalently characterize the QND property of the quantum measurement, the target experimental QND fidelity Q_{E} still has practical significance and can partially reflect the QND property of the quantum measurement.

In conclusion, FIG. 4 shows the relationship among the target theoretical QND fidelity Q_{D}, the target experimental QND fidelity Q_{E} and the QND property (i.e., the QND measurement) proposed in the disclosed solution, that is, the target theoretical QND fidelity Q_{D} can completely and equivalently characterize the QND property of the measurement, while the target experimental QND fidelity Q_{E} cannot completely and equivalently characterize the QND property of the measurement, but has more advantages in experimental implementation and can give an achievable upper limit of the target theoretical QND fidelity Q_{D}.

Second part: a calculation method of metrics that quantitatively characterize quantum non-demolition

The specific process of determining the target theoretical QND fidelity Q_{D} will be described below, and as shown in FIG. 8, the specific steps are as follows.

Step 1: give a set of computational basis states |k [symbol] k|, where k=0, 1, . . . , N−1, and the value of N is a natural number greater than or equal to 1 and corresponds to the quantity of energy levels to be considered, and for example, is the quantity of energy levels of a quantum system to be measured.

Step 2: perform quantum state chromatography on the computational basis state |k [symbol] k| to obtain an output quantum state ε(|k [symbol] k|).

Step 3: calculate and obtain the trace distance D_{D,k}=D(|k [symbol] k|, ε(|k [symbol] k|)) corresponding to the computational basis state |k [symbol] k| based on the output quantum state ε(|k [symbol] k|) and the computational basis state |k [symbol] k|, and then calculate and obtain the sub-theoretical QND fidelity Q_{D,k}=1−D_{D,k} corresponding to the computational basis state |k [symbol] k|.

Step 4: judge whether k is greater than N−1; if not, set k=k+1, and return to Step 2 to obtain the sub-theoretical QND fidelity Q_{D,k+1} corresponding to the computational basis state |k+1 [symbol] k+1|; if so, perform Step 5.

That is to say, in the case of k≠N−1, k is updated to k+1, and then the sub-theoretical QND fidelity Q_{D,k+1} corresponding to the computational basis state |k+1 [symbol] k+1| is calculated based on the method of Steps 2 and 3. This cycle is repeated to directly obtain all sub-theoretical QND fidelities, namely {Q_{D,k}, k=0, 1, . . . , N−1}.

Step 5: calculate the average value of N sub-theoretical QND fidelities, and take the average value as the target theoretical QND fidelity Q_{D}.

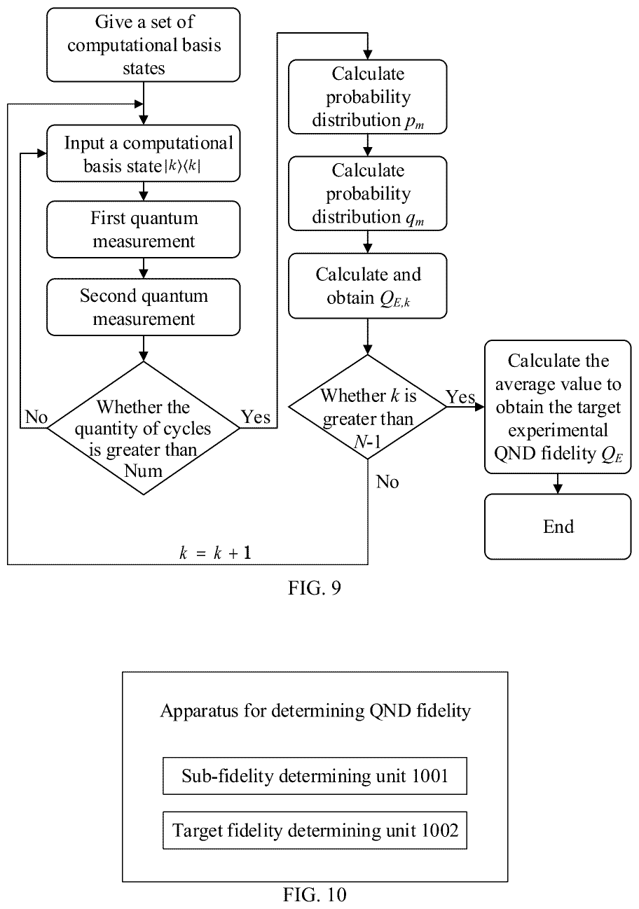

The specific process of determining the target experimental QND fidelity Q_{E} will be described below, and as shown in FIG. 9, the specific steps include the followings.

Step 1: give a set of computational basis states |k [symbol] k|, where k=0, 1, . . . , N−1, and the value of N is a natural number greater than or equal to 1 and corresponds to the quantity of energy levels to be considered, and for example, is the quantity of energy levels of a quantum system to be measured.

Step 2: input a computational basis state |k [symbol] k|.

Step 3: perform the first quantum measurement on the computational basis state |k [symbol] k| to obtain an output quantum state after the first quantum measurement.

Step 4: perform the second quantum measurement on the output quantum state after the first quantum measurement.

Step 5: judge whether the quantity of cycles of the second quantum measurement for the computational basis state |k [symbol] k| is greater than a preset value Num; if not, return to Step 2 to continue the quantum measurement; if so, perform Step 6.

Herein, the preset value Num may be a sufficiently large fixed value, for example, 1024 or more.

Furthermore, it can be understood that the quantity of times the first quantum measurement is performed may be the same as the quantity of times the second quantum measurement is performed, and both are the preset value Num; and in this way, it is convenient for subsequent calculations to obtain the probability distributions corresponding to the two measurements. Alternatively, the numbers of times of the two quantum measurements are different. Herein, considering that the second quantum measurement is to measure the output quantum state obtained after the first quantum measurement, so the quantity of times the first quantum measurement is performed may also be greater than the total quantity of times the second quantum measurement is performed, which is not limited in the disclosed solution, as long as the classical probability distributions of the two quantum measurements can be statistically obtained.

Step 6: count the quantity of times C_{1,m} the output result of the first quantum measurement of the computational basis state |k [symbol] k| is m, and obtain the probability distribution pₘ(ρₖ)=C_{1,m}/Num that the output result of the first quantum measurement is m, where ρₖ=|k [symbol] k|.

Step 7: count the quantity of times C_{2,m} the output result of the second quantum measurement is m in the process of performing the second quantum measurement on the output quantum state after the first quantum measurement, and obtain the probability distribution qₘ(ρₖ)=C_{2,m}/Num that the output result of the second quantum measurement is m, where ρₖ=|k [symbol] k|.

It can be understood that the execution order of the above Steps 6 and 7 may be exchanged in practical applications, that is, the probability distribution qₘ(ρₖ) corresponding to the second quantum measurement is obtained firstly, and then the probability distribution pₘ(ρₖ) of the first quantum measurement is obtained.

Step 8: obtain the destructiveness (that is, the distance D_{E,k}(|k [symbol] k|)=D(pₘ(|k [symbol] k|), qₘ(|k [symbol] k|))) that defines the quantum measurement based on the obtained probability distribution pₘ(ρₖ) and probability distribution qₘ(ρₖ), and then obtain the sub-experimental QND fidelity Q_{E,k}=1−D_{E,k} corresponding to the computational basis state |k [symbol] k|.

It should be noted that the output result of the second quantum measurement is counted without concerning the output result of the first quantum measurement. In other words, as shown in FIG. 7(b), in the step of counting the output result of the second quantum measurement as m, the output result of the first quantum measurement may be the same as or different from the output result of the second quantum measurement; for example, the output results of the two quantum measurements are both m, or the output result of the first quantum measurement is n, where n is different from m.

Step 9: judge whether k is greater than N−1; if not, set k=k+1, and return to Step 2 to obtain the sub-experimental QND fidelity Q_{E,k}+1 corresponding to the computational basis state |k+1 [symbol] k+1|; if so, perform Step 10.

That is to say, in the case of k≠N−1, k is updated to k+1, and then the sub-experimental QND fidelity Q_{E,k}+1 corresponding to the computational basis state |k+1 [symbol] k+1| is calculated based on the method of Steps 2 to 8. This cycle is repeated to directly obtain all sub-experimental QND fidelities, namely {Q_{E,k}, k=0, 1, . . . , N−1}.

Step 10: calculate the average value of N sub-experimental QND fidelities, and take the average value as the target experimental QND fidelity Q_{E}.

The target experimental QND fidelity Q_{E} is the upper limit of the theoretical QND fidelity Q_{D}.

Herein, the QND property of the quantum measurement is that the expected value of the observation remains unchanged before and after the quantum measurement. From the above definition, it can be seen that two measurements are required to characterize the QND property of the quantum measurement. However, it can be seen from the above argument that it is an intuitive translation of the definition to only compare the probabilities of the two quantum measurements to output the same value to define the QND fidelity (i.e., F_{Q}), and it can be seen from the above proof that the QND fidelity F_{Q} has a problem. As shown in FIG. 2, although there is an overlap between the QND fidelity F_{Q} and the QND property, the QND fidelity F_{Q} will deviate from the characterization of the QND property of the measurement quantum under certain conditions. In order to solve the above problem, the present disclosure provides the target theoretical QND fidelity Q_{D} and the target experimental QND fidelity Q_{E}, and designs the corresponding experimental processes, so as to solve the problem that the QND fidelity F_{Q} cannot effectively characterize the QND property of the quantum measurement.

Thus, the target theoretical QND fidelity and target experimental QND fidelity as well as the corresponding experimental method provided in the disclosed solution are of great help in evaluating the performance of qubit reading, and may be used widely in the design of qubit reading.

The disclosed solution also provides an apparatus for determining QND fidelity, as shown in FIG. 10, including: a sub-fidelity determining unit 1001 configured to determine a sub-QND fidelity Qₖ obtained after a quantum measurement of a k^{th} input quantum state; where k is any one of 0, 1, 2 . . . , or N−1, and N is a natural number greater than or equal to 1 and represents a quantity of input quantum states required; and a target fidelity determining unit 1002 configured to obtain a target QND fidelity based on the sub-QND fidelity Qₖ, where the target QND fidelity is used to measure whether the quantum measurement satisfies a QND property.

In a specific example of the disclosed solution, the target fidelity determining unit is specifically configured to: obtain an average QND fidelity corresponding to the quantum measurement based on the sub-QND fidelity Qₖ; and take the average QND fidelity as the target QND fidelity.

In a specific example of the disclosed solution, the target QND fidelity includes at least one of: a target theoretical QND fidelity Q_{D}, where the target theoretical QND fidelity Q_{D} is within a first preset range when and only when the quantum measurement satisfies the QND property; and a target experimental QND fidelity Q_{E}, where the quantum measurement satisfies the QND property, in a case of the target experimental QND fidelity Q_{E} is within the first preset range and the quantum measurement satisfies a preset condition.

In a specific example of the disclosed solution, the target theoretical QND fidelity Q_{D} is within a second preset range when and only when the quantum measurement does not satisfy the QND property.

In a specific example of the disclosed solution, the quantum measurement does not satisfy the QND property in a case of the target experimental QND fidelity Q_{E} is within a second preset range.

In a specific example of the disclosed solution, the target theoretical QND fidelity Q_{D} is less than or equal to the target experimental QND fidelity Q_{E}.

In a specific example of the disclosed solution, the sub-fidelity determining unit is further configured to: obtain a k^{th} output quantum state obtained after performing quantum state chromatography on the k^{th} input quantum state; determine a trace distance between the k^{th} input quantum state and the k^{th} output quantum state, where the trace distance between the k^{th} input quantum state and the k^{th} output quantum state is used to measure destructiveness of performing the quantum state chromatography on the k^{th} input quantum state; and obtain the sub-QND fidelity Qₖ corresponding to the k^{th} input quantum state based on the trace distance between the k^{th} input quantum state and the k^{th} output quantum state; where the sub-QND fidelity Qₖ is a sub-theoretical QND fidelity Q_{D,k}.

In a specific example of the disclosed solution, the target fidelity determining unit is specifically configured to: obtain a target theoretical QND fidelity Q_{D} based on the sub-theoretical QND fidelity Q_{D,k}, where the target theoretical QND fidelity Q_{D} is used to measure whether the quantum measurement satisfies the QND property.

In a specific example of the disclosed solution, the k^{th} input quantum state is a computational basis state |k [symbol] k|.

In a specific example of the disclosed solution, the sub-fidelity determining unit is further configured to: determine a probability distribution pₘ(ρₖ) and probability distribution qₘ(ρₖ) corresponding to the k^{th} input quantum state, where ρₖ is a density matrix of the k^{th} input quantum state, the probability distribution pₘ(ρₖ) represents a probability that an output result of a first quantum measurement of the k^{th} input quantum state is m, and the probability distribution qₘ(ρₖ) represents a probability that an output result of a second quantum measurement of an output quantum state after the first quantum measurement of the k^{th} input quantum state is m; obtain a distance between the probability distribution pₘ(ρₖ) and the probability distribution qₘ(ρₖ) based on the probability distribution pₘ(ρₖ) and the probability distribution qₘ(ρₖ); where the distance between the probability distribution pₘ(ρₖ) and the probability distribution qₘ(ρₖ) is used to characterize destructiveness of performing the quantum measurement on the k^{th} input quantum state; and obtain the sub-QND fidelity Qₖ corresponding to the k^{th} input quantum state based on the distance between the probability distribution pₘ(ρₖ) and the probability distribution qₘ(ρₖ); where the sub-QND fidelity Qₖ is a sub-experimental QND fidelity Q_{E,k}.

In a specific example of the disclosed solution, the target fidelity determining unit is specifically configured to: obtain a target experimental QND fidelity Q_{E} based on the sub-experimental QND fidelity Q_{E,k}, where the target experimental QND fidelity Q_{E} is used to measure whether the quantum measurement satisfies the QND property.

In a specific example of the disclosed solution, the k^{th} input quantum state is a computational basis state |k [symbol] k|, and ρₖ=|k [symbol] k|.

For the description of specific functions and examples of the units of the apparatus of the embodiment of the present disclosure, reference may be made to the relevant description of the corresponding steps in the above-mentioned method embodiments, and details are not repeated herein.

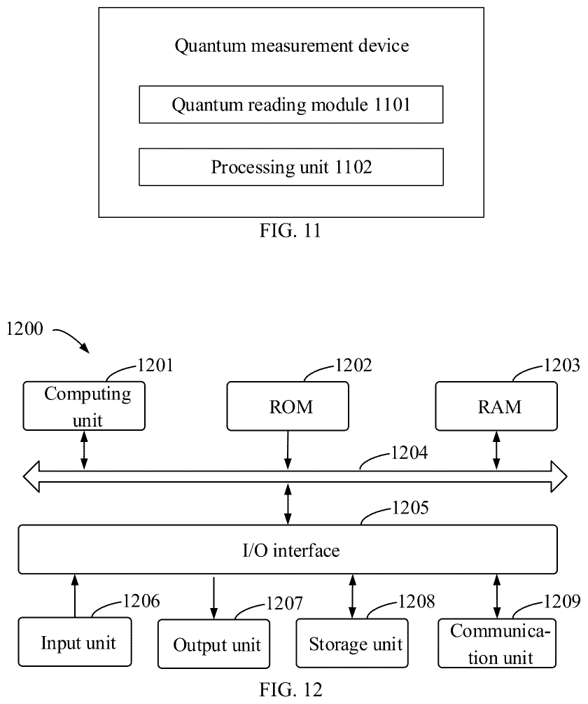

The disclosed solution also provides a quantum measurement device, as shown in FIG. 11, including: a quantum reading module 1101 configured to obtain a k^{th} input quantum state, and perform a quantum measurement on the P h input quantum state to obtain a k^{th} output quantum state; and a processing unit 1102 configured to determine a sub-QND fidelity Qₖ obtained after the quantum measurement of the k^{th} input quantum state; where k is any one of 0, 1, 2 . . . , or N−1, and N is a natural number greater than or equal to 1 and represents a quantity of input quantum states required; and obtain a target QND fidelity based on the sub-QND fidelity Qₖ, where the target QND fidelity is used to measure whether the quantum measurement satisfies a QND property.

In a specific example, the quantum reading module is further configured to perform quantum state chromatography on the k^{th} input quantum state, and obtain the k^{th} output quantum state.

Further, the processing unit may also execute at least a part of the followings.

In a specific example, the processing unit is specifically configured to: obtain an average QND fidelity corresponding to the quantum measurement based on the sub-QND fidelity Qₖ; and take the average QND fidelity as the target QND fidelity.

In a specific example, the target QND fidelity includes at least one of: a target theoretical QND fidelity Q_{D}, where the target theoretical QND fidelity Q_{D} is within a first preset range when and only when the quantum measurement satisfies the QND property; and a target experimental QND fidelity Q_{E}, where the quantum measurement satisfies the QND property, in a case of the target experimental QND fidelity Q_{E} is within the first preset range and the quantum measurement satisfies a preset condition.

In a specific example, the target theoretical QND fidelity Q_{D} is within a second preset range when and only when the quantum measurement does not satisfy the QND property.

In a specific example, the quantum measurement does not satisfy the QND property in a case of the target experimental QND fidelity Q_{E} is within a second preset range.

In a specific example, the target theoretical QND fidelity Q_{D} is less than or equal to the target experimental QND fidelity Q_{E}.

In a specific example, the processing unit is further configured to: obtain a k^{th} output quantum state obtained after performing quantum state chromatography on the k^{th} input quantum state; determine a trace distance between the k^{th} input quantum state and the k^{th} output quantum state, where the trace distance between the k^{th} input quantum state and the k^{th} output quantum state is used to measure destructiveness of performing the quantum state chromatography on the k^{th} input quantum state; and obtain the sub-QND fidelity Q k corresponding to the k^{th} input quantum state based on the trace distance between the k^{th} input quantum state and the k^{th} output quantum state; where the sub-QND fidelity Qₖ is a sub-theoretical QND fidelity Q_{D,k}.

In a specific example, the processing unit is specifically configured to: obtain a target theoretical QND fidelity Q_{D} based on the sub-theoretical QND fidelity Q_{D,k}, where the target theoretical QND fidelity Q_{D} is used to measure whether the quantum measurement satisfies the QND property.

In a specific example, the k^{th} input quantum state is a computational basis state |k [symbol] k|.

In a specific example, the processing unit is further configured to: determine a probability distribution pₘ(ρₖ) and probability distribution qₘ(ρₖ) corresponding to the k^{th} input quantum state, where ρₖ is a density matrix of the k^{th} input quantum state, the probability distribution pₘ(ρₖ) represents a probability that an output result of a first quantum measurement of the k^{th} input quantum state is m, and the probability distribution qₘ(ρₖ) represents a probability that an output result of a second quantum measurement of an output quantum state after the first quantum measurement of the k^{th} input quantum state is m; obtain a distance between the probability distribution pₘ(ρₖ) and the probability distribution qₘ(ρₖ) based on the probability distribution pₘ(ρₖ) and the probability distribution qₘ(ρₖ); where the distance between the probability distribution pₘ(ρₖ) and the probability distribution qₘ(ρₖ) is used to characterize destructiveness of performing the quantum measurement on the k^{th} input quantum state; and obtain the sub-QND fidelity Qₖ corresponding to the k^{th} input quantum state based on the distance between the probability distribution pₘ(ρₖ) and the probability distribution qₘ(ρₖ); where the sub-QND fidelity Qₖ is a sub-experimental QND fidelity Q_{E,k}.

For the description of specific functions and examples of the processing unit of the quantum measurement device of the embodiment of the present disclosure, reference may be made to the relevant description of the corresponding steps in the above-mentioned method embodiments, and details are not repeated herein.

According to the embodiments of the present disclosure, the present disclosure also provides an electronic device, a readable storage medium and a computer program product.

FIG. 12 shows a schematic block diagram of an exemplary electronic device 1200 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital processing, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 12, the device 1200 includes a computing unit 1201 that may perform various appropriate actions and processes according to a computer program stored in a Read-Only Memory (ROM) 1202 or a computer program loaded from a storage unit 1208 into a Random Access Memory (RAM) 1203. Various programs and data required for an operation of device 1200 may also be stored in the RAM 1203. The computing unit 1201, the ROM 1202 and the RAM 1203 are connected to each other through a bus 1204. The input/output (I/O) interface 1205 is also connected to the bus 1204.

A plurality of components in the device 1200 are connected to the I/O interface 1205, and include an input unit 1206 such as a keyboard, a mouse, or the like; an output unit 1207 such as various types of displays, speakers, or the like; the storage unit 1208 such as a magnetic disk, an optical disk, or the like; and a communication unit 1209 such as a network card, a modem, a wireless communication transceiver, or the like. The communication unit 1209 allows the device 1200 to exchange information/data with other devices through a computer network such as the Internet and/or various telecommunication networks.

The computing unit 1201 may be various general-purpose and/or special-purpose processing components with processing and computing capabilities. Some examples of the computing unit 1201 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 1201 performs various methods and processing described above, such as the method for determining QND fidelity. For example, in some implementations, the method for determining QND fidelity may be implemented as a computer software program tangibly contained in a computer-readable medium, such as the storage unit 1208. In some implementations, a part or all of the computer program may be loaded and/or installed on the device 1200 via the ROM 1202 and/or the communication unit 1209. When the computer program is loaded into RAM 1203 and executed by the computing unit 1201, one or more steps of the method for determining QND fidelity described above may be performed. Alternatively, in other implementations, the computing unit 1201 may be configured to perform the method for determining QND fidelity by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), Application Specific Standard Parts (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the spirit and principle of the present disclosure shall be included in the protection scope of the present disclosure.

What is claimed is:

1. A method for determining Quantum Non-Demolition (QND) fidelity, comprising:
determining a sub-QND fidelity Qₖ obtained after a quantum measurement of a k^{th} input quantum state; wherein k is any one of 0, 1, 2 . . . , or N−1, and N is a natural number greater than or equal to 1 and represents a quantity of input quantum states required; and
obtaining a target QND fidelity based on the sub-QND fidelity Qₖ, wherein the target QND fidelity is used to measure whether the quantum measurement satisfies a QND property.

2. The method of claim 1, wherein obtaining the target QND fidelity based on the sub-QND fidelity Qₖ, comprises:
obtaining an average QND fidelity corresponding to the quantum measurement based on the sub-QND fidelity Qₖ; and
taking the average QND fidelity as the target QND fidelity.

3. The method of claim 1, wherein the target QND fidelity comprises at least one of:
a target theoretical QND fidelity Q_{D}, wherein the target theoretical QND fidelity Q_{D} is within a first preset range when and only when the quantum measurement satisfies the QND property; and
a target experimental QND fidelity Q_{E}, wherein the quantum measurement satisfies the QND property, in a case of the target experimental QND fidelity Q_{E} is within the first preset range and the quantum measurement satisfies a preset condition.

4. The method of claim 2, wherein the target QND fidelity comprises at least one of:
a target theoretical QND fidelity Q_{D}, wherein the target theoretical QND fidelity Q_{D} is within a first preset range when and only when the quantum measurement satisfies the QND property; and
a target experimental QND fidelity Q_{E}, wherein the quantum measurement satisfies the QND property, in a case of the target experimental QND fidelity Q_{E} is within the first preset range and the quantum measurement satisfies a preset condition.

5. The method of claim 3, wherein the target theoretical QND fidelity Q_{D} is within a second preset range when and only when the quantum measurement does not satisfy the QND property.

6. The method of claim 4, wherein the target theoretical QND fidelity Q_{D} is within a second preset range when and only when the quantum measurement does not satisfy the QND property.

7. The method of claim 3, wherein the quantum measurement does not satisfy the QND property in a case of the target experimental QND fidelity Q_{E} is within a second preset range.

8. The method of claim 4, wherein the quantum measurement does not satisfy the QND property in a case of the target experimental QND fidelity Q_{E} is within a second preset range.

9. The method of claim 3, wherein the target theoretical QND fidelity Q_{D} is less than or equal to the target experimental QND fidelity Q_{E}.

10. The method of claim 4, wherein the target theoretical QND fidelity Q_{D} is less than or equal to the target experimental QND fidelity Q_{E}.

11. The method of claim 1, further comprising:
obtaining a k^{th} output quantum state obtained after performing quantum state chromatography on the k^{th} input quantum state; and
determining a trace distance between the k^{th} input quantum state and the k^{th} output quantum state, wherein the trace distance between the k^{th} input quantum state and the k^{th} output quantum state is used to measure destructiveness of performing the quantum state chromatography on the k^{th} input quantum state;
wherein determining the sub-QND fidelity Qₖ obtained after the quantum measurement of the k^{th} input quantum state, comprises:
obtaining the sub-QND fidelity Qₖ corresponding to the k^{th} input quantum state based on the trace distance between the k^{th} input quantum state and the k^{th} output quantum state; wherein the sub-QND fidelity Qₖ is a sub-theoretical QND fidelity Q_{D,k}.

12. The method of claim 2, further comprising:
obtaining a k^{th} output quantum state obtained after performing quantum state chromatography on the k^{th} input quantum state; and
determining a trace distance between the k^{th} input quantum state and the k^{th} output quantum state, wherein the trace distance between the k^{th} input quantum state and the k^{th} output quantum state is used to measure destructiveness of performing the quantum state chromatography on the k^{th} input quantum state;
wherein determining the sub-QND fidelity Qₖ obtained after the quantum measurement of the k^{th} input quantum state, comprises:
obtaining the sub-QND fidelity Qₖ corresponding to the k^{th} input quantum state based on the trace distance between the k^{th} input quantum state and the k^{th} output quantum state; wherein the sub-QND fidelity Qₖ is a sub-theoretical QND fidelity Q_{D,k}.

13. The method of claim 11, wherein obtaining the target QND fidelity based on the sub-QND fidelity Qₖ, comprises:
obtaining a target theoretical QND fidelity Q_{D} based on the sub-theoretical QND fidelity Q_{D,k}, wherein the target theoretical QND fidelity Q_{D} is used to measure whether the quantum measurement satisfies the QND property.

14. The method of claim 12, wherein obtaining the target QND fidelity based on the sub-QND fidelity Qₖ, comprises:
obtaining a target theoretical QND fidelity Q_{D} based on the sub-theoretical QND fidelity Q_{D,k}, wherein the target theoretical QND fidelity Q_{D} is used to measure whether the quantum measurement satisfies the QND property.

15. The method of claim 11, wherein the k^{th} input quantum state is a computational basis state |k [symbol] k|.

16. The method of claim 1, further comprising:
determining a probability distribution pₘ(ρₖ) and probability distribution qₘ(ρₖ) corresponding to the k^{th} input quantum state, wherein ρₖ is a density matrix of the k^{th} input quantum state, the probability distribution pₘ(ρₖ) represents a probability that an output result of a first quantum measurement of the k^{th} input quantum state is m, and the probability distribution qₘ(ρₖ) represents a probability that an output result of a second quantum measurement of an output quantum state after the first quantum measurement of the k^{th} input quantum state is m; and
obtaining a distance between the probability distribution pₘ(ρₖ) and the probability distribution qₘ(ρₖ) based on the probability distribution pₘ(ρₖ) and the probability distribution qₘ(ρₖ); wherein the distance between the probability distribution pₘ(ρₖ) and the probability distribution qₘ(ρₖ) is used to characterize destructiveness of performing the quantum measurement on the k^{th} input quantum state;
wherein determining the sub-QND fidelity Qₖ obtained after the quantum measurement of the k^{th} input quantum state, comprises:
obtaining the sub-QND fidelity Qₖ corresponding to the k^{th} input quantum state based on the distance between the probability distribution pₘ(ρₖ) and the probability distribution qₘ(ρₖ); wherein the sub-QND fidelity Qₖ is a sub-experimental QND fidelity Q_{E,k}.

17. The method of claim 16, wherein obtaining the target QND fidelity based on the sub-QND fidelity Qₖ, comprises:
obtaining a target experimental QND fidelity Q_{E} based on the sub-experimental QND fidelity Q_{E,k}, wherein the target experimental QND fidelity Q_{E} is used to measure whether the quantum measurement satisfies the QND property.

18. The method of claim 16, wherein the k^{th} input quantum state is a computational basis state |k [symbol] k|, and ρₖ=|k [symbol] k|.

19. An electronic device, comprising:
at least one processor; and
a memory connected in communication with the at least one processor;
wherein the memory stores an instruction executable by the at least one processor, and the instruction, when executed by the at least one processor, enables the at least one processor to execute:
determining a sub-QND fidelity Qₖ obtained after a quantum measurement of a k^{th} input quantum state; wherein k is any one of 0, 1, 2 . . . , or N−1, and N is a natural number greater than or equal to 1 and represents a quantity of input quantum states required; and
obtaining a target QND fidelity based on the sub-QND fidelity Qₖ, wherein the target QND fidelity is used to measure whether the quantum measurement satisfies a QND property.

20. A non-transitory computer-readable storage medium storing a computer instruction thereon, wherein the computer instruction is used to cause a computer to execute:
determining a sub-QND fidelity Qₖ obtained after a quantum measurement of a k^{th} input quantum state; wherein k is any one of 0, 1, 2 . . . , or N−1, and N is a natural number greater than or equal to 1 and represents a quantity of input quantum states required; and
obtaining a target QND fidelity based on the sub-QND fidelity Qₖ, wherein the target QND fidelity is used to measure whether the quantum measurement satisfies a QND property.
